(19) United States
(12) Patent Application Publication
(10) Pub. No.: US 2025/0094834 A1
(43) Pub. Date: Mar. 20, 2025

(54) Predicting monitoring device of the operation of a unit for estimating a physical value and associated system and methods

(71) Applicant: THALES, Meudon (FR)

(72) Inventors: Fateh KAAKAI, PALAISEAU CEDEX (FR); Paul-Marie RAFFI, RUNGIS CEDEX (FR)

(21) Appl. No.: 18/885,685

(22) Filed: Sep. 15, 2024

(30) Foreign Application Priority Data
Sep. 18, 2023 (FR) 2309817

(51) Int. Cl. G06N 5/022

(52) U.S. Cl. CPC G06N 5/022

(57) ABSTRACT

A predictive monitoring device for operation of a unit for estimating a physical quantity receiving data acquired by a detection unit and applying an estimation model to the acquired data, the predictive monitoring device including a generation unit for test data, applying a transformation to the acquired data, a computation unit estimating a value of the physical quantity by applying the model to the test data, an analysis unit for the test value, performing a comparison between the test value and an expected value according to a criterion for evaluating the performance of the model, and a warning unit issuing an alert according to the result of the comparison.

### REFERENCE TO RELATED APPLICATION

This application is a U.S. non-provisional application claiming the benefit of French Application No. 23 09817, filed on Sep. 18, 2023, the contents of which are incorporated herein by reference in their entirety.

### TECHNICAL FIELD OF THE INVENTION

The present invention relates to a device for predictive monitoring of the operation of a unit for estimating a physical quantity. Same further relates to an estimation system comprising such a predictive monitoring device. The present invention relates to associated monitoring and estimation methods.

### BACKGROUND OF THE INVENTION

As part of the development of critical systems involving stringent safety goals and requirements, verifications are carried out on the robustness and stability of the systems developed during the design phase. Such verifications are carried out in particular by means of test campaigns and tooled sensitivity analyzes.

Artificial intelligence technologies are increasingly being used to develop models derived from data-driven machine learning in critical systems.

Such models in particular are estimation models adapted to give an estimated value of the physical quantity over a predefined operational domain.

The predefined operational domain is, by definition, the set of operating conditions under which the estimation model is specifically designed to operate, including, but not limited to, environmental, geographical and time restrictions.

An estimation model is considered robust when the estimation model may continue to function properly despite abnormal inputs and conditions outside the predefined operational domain.

An estimation model is considered stable if same may continue to function properly despite disturbances in the inputs thereof within the predefined operational domain.

Robustness and stability are more difficult to verify for systems designed by data-driven machine learning. Indeed, little formal methods exist and same are often limited to certain model classes.

Furthermore, it is not possible to multiply indefinitely the number of data in learning datasets for obvious reasons of data availability and of viability of the industrial cost of the activities of verification.

There is thus a need for a predictive monitoring device for the operation of a unit for estimating a physical quantity to control the robustness and stability of a tool obtained by machine learning.

### SUMMARY OF THE INVENTION

To this end, the description describes a device of predictive monitoring for the operation of a unit for estimating a physical quantity,
the estimation unit receiving data acquired by a detection unit and applying an estimation model on acquired data to obtain an estimated value, the estimation model being suitable for giving an estimated value of the physical quantity over a predefined operational domain,
the predictive monitoring device comprising:
   a generation unit for test data, the generation unit receiving the data acquired by the detection unit and applying a transformation on the acquired data to obtain test data, the test data being data observable by the detection unit and on which the application of the estimation model gives an expected value,
   a computation unit estimating a value of the physical quantity by applying to the test data, the same estimation model as the estimation unit to obtain a test value,
   an analysis unit for the test value, the analysis unit performing at least one comparison between the test value and an expected value according to at least one criterion for obtaining a comparison result, each criterion being a criterion for evaluating the performance of the estimation model, and
   a warning unit issuing an alert according to the result of the comparison.

According to particular embodiments, the predictive monitoring device has one or a plurality of the following features, taken individually or according to all technically possible combinations:
a transformation that the generation unit is adapted to apply is a transformation adding noise into the acquired data.
a transformation that the generation unit is adapted to apply is a function of generating abnormal data, an abnormal datum being a datum that does not belong to the predefined operational domain.
a criterion used by the analysis unit is a criterion of robustness of the estimation model and the expected value is an indication of the presence of an abnormal datum at the input of the estimation model.
one criterion used by the analytical unit is a stability criterion and the expected value is the estimated value.
the warning unit is adapted to issue an alert when, for a number of times greater than a predefined threshold, the result of the comparison corresponds to a criterion that has not been fulfilled.

The description also describes a system for estimating a physical quantity, the estimation system comprising:
the estimation unit adapted to receive data acquired by a detection unit and being adapted to apply an estimation model on acquired data to obtain an estimated value, the estimation model being suitable for giving an estimated value of the physical quantity over a predefined operational domain, and
   a predictive monitoring device of the estimation unit, the monitoring device being as described hereinabove.

According to particular embodiments, the estimation method has one or a plurality of the following features, taken individually or according to all technically possible combinations:
the estimation system further comprises a detection unit adapted to acquire acquired data, and
the estimation system further includes a control unit adapted to issue an output value for the estimation system depending both on the estimated value and on an output of the warning unit.

The description further describes a predictive monitoring of the operation of a unit for estimating a physical quantity,
the estimation unit receiving data acquired by a detection unit and applying an estimation model on acquired data to obtain an estimated value, the estimation model being suitable for giving an estimated value of the physical quantity over a predefined operational domain,
the method comprising:
   an implemented step of generation of test data, the generation step comprising reception of the data acquired by the detection unit and application of a transformation on the acquired data to obtain test data, the test data being data observable by the detection unit and on which the application of the estimation model gives an expected value,
   a computation step comprising estimation of a value of the physical quantity by applying to the test data, the same estimation model as the estimation unit, in order to obtain a test value,
   a step of analysis of the test value, the analysis step comprising at least one comparison between the test value and an expected value according to at least one criterion for obtaining a comparison result, each criterion being a criterion for evaluating the performance of the estimation model, and
   a warning step comprising the issuing of an alert according to the result of the comparison.

The description further relates to a method of estimation of a physical quantity comprising:
an estimation step, implemented by an estimation unit and comprising reception of data acquired by a detection unit and application of an estimation model on acquired data to obtain an estimated value, the estimation model being suitable for giving an estimated value of the physical quantity over a predefined operational domain, and
a step of implementing a predictive monitoring method as described hereinabove.

In the present description, the expression “adapted to” means equally well “apt to”; “suitable for” or “configured for”.

### BRIEF DESCRIPTION OF THE DRAWINGS

The features and advantages of the invention will appear upon reading the following description, given only as an example, but not limited to, and making reference to the enclosed drawings, wherein:

FIG. 1 is a schematic representation of an estimation system of a physical quantity comprising a predictive monitoring device; and

FIG. 2 is a schematic view of the predictive monitoring device shown in FIG. 1.

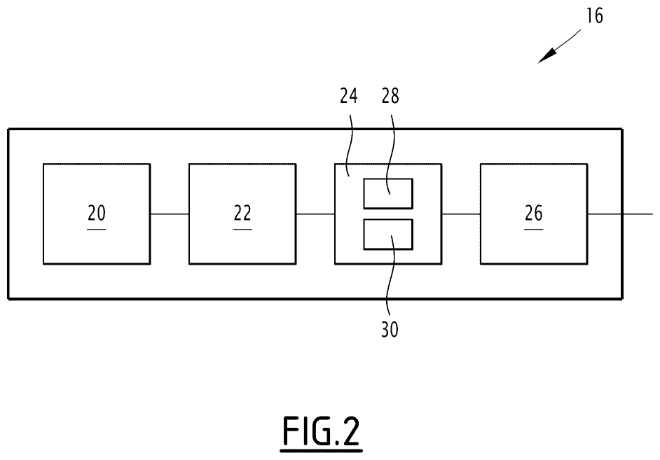

### DETAILED DESCRIPTION OF EMBODIMENTS

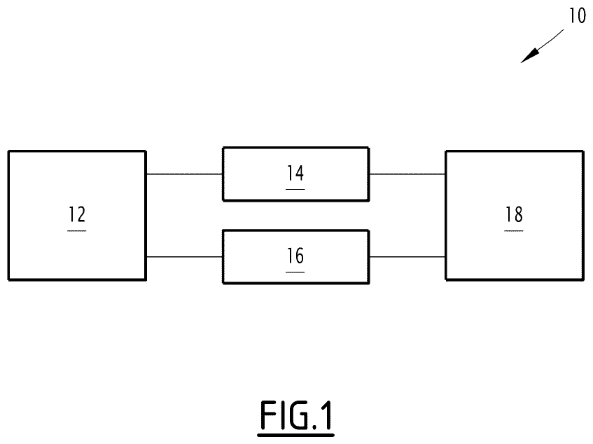

FIG. 1 is an estimation system 10 including a detection unit 12, an estimation unit 14, a predictive monitoring device 16 and a control unit 18.

The estimation system 10 is suitable for estimating a physical quantity.

The physical quantity may be of any type, the estimation system 10 thereby serving as a measurement system.

The detection unit 12 is suitable for acquiring data.

As such, the detection unit 12 includes one or a plurality of sensors adapted to collect data.

The data collected are thereby measurements.

According to the example described, the detection unit 12 is a camera, the camera supplying images.

The data acquired by the detection unit 12 are thereby images.

In a variant or in addition, the detection unit 12 may include any type of sensor, and in particular sensors suitable for collecting signals such as audio, video, time series, tabular data signals or any other type of signal.

The estimation unit 14 is a unit for estimating a physical quantity.

The estimation unit 14 is adapted to receive the data acquired by the detection unit 12.

The estimation unit 14 is suitable for applying an estimation model to acquired data in order to obtain an estimated value, which corresponds to the value of the physical quantity sought.

The estimation model is a model derived from artificial intelligence and in particular a model obtained by machine learning.

As a result, the estimation model has been trained on necessarily incomplete data, which justifies the presence of the monitoring device 16.

As an example, the estimation model is a neural network.

The estimation model is suitable for giving an estimated value of the physical quantity over a predefined operational domain.

The predefined operational domain is, by definition, the set of operating conditions under which the estimation model is specifically designed to operate, including, but not limited to, environmental, geographical and time restrictions.

The predefine operational domain is often referred to by the abbreviation ODD (operational design domain).

In order to determine the predefined operational domain of an AI model, the performance of the model should be measured under operational conditions as close as possible to actual conditions (i.e., nominal and abnormal conditions).

Using the results of model inference on input data containing nominal values and anomalies, the predefined operational domain ODD of the model is characterized by the measured parameter ranges (e.g., image brightness) for which the model provides good output within an acceptable margin of error.

The predefined ODD of the model serves as a reference for the monitoring device 16, as same corresponds to the field wherein the estimation model guarantees the expected behavior and performance level.

The monitoring device 16 is suitable for monitoring the operation of the estimation unit 14.

The monitoring device 16 serves to check that the estimation unit 14 is functioning correctly or, more precisely, will function correctly as explained hereinafter in the description.

In such context, the expression “functioning properly” refers to a correct functioning of the estimation unit in the future (in production or in operation), which gives the monitoring carried out by the monitoring device 16 a predictive aspect. In the sense thereof, the monitoring device 16 being a predictive monitoring device.

The monitoring device 16 includes a generation unit 20, a computation unit 22, an analysis unit 24 and a warning unit 26.

The generation unit 20 is a generation unit for test data.

The generation unit 20 is suitable for receiving the data acquired by the detection unit 12.

The data received by the generation unit 20 are thus the same data as the data received by the estimation unit 14.

The generation unit 20 and the estimation unit 14 thus use the same input data.

In order to obtain test data, the generation unit 20 is adapted to apply a transformation to the acquired data.

In the above sense, the test data is acquired data that were perturbed.

Each test datum is a datum that may be observed by the detection unit 12 and for which the application of the estimation model will give an expected value. Such “observable” character means that the data are data that can be observed under actual operating conditions such as the failure of a sensor or an operating condition outside the predefined operational domain.

A datum is a datum that may be observed when same is representative of an environment that can occur in a real case.

Observing snow in the middle of summer on a beach where the temperature has been 40° C. for several weeks is, e.g., not a datum that may be observed in real life.

The expected value is usually either the value of the physical quantity or an output error code, the case having never been encountered by the model.

A plurality of examples of transformation illustrating a possible operation of the generation unit 20 are now described.

According to a first use case relating to the monitoring of the stability of the estimation unit 14, the generation unit 20 is adapted to apply a transformation adding noise into the acquired data. The test data are then noisy data.

By applying such a transformation, the generation unit 20 is adapted to ensure that the noisy data stay within the predefined operational domain.

According to a second use case relating to the monitoring of the robustness of the estimation unit 14, the generation unit 20 is suitable for applying a function generating abnormal data.

In such context, an abnormal datum is a datum that does not belong to the predefined operational domain.

In such a case, thereof implies that the estimation model taking as input an abnormal datum should, in normal operation, interpret such datum as an anomaly not to be processed. Typically, the estimation model will output an error code or a classification of the abnormal datum as an unknown datum.

For example, in the case of acquired data that are images, examples of transformations are rotations and/or translations of the original image.

It is also possible to apply a transformation to obtain at the output images deliberately blurred, colored, obscured, too bright, too opaque, containing noise or a simulation of “dead” pixels or rows or columns of “dead” pixels.

According to another example, the acquired data are a set of measurements the time variation of which is monitored. The acquired data are then time series.

In such an example, a transformation is, as an illustration, a function modulating an amplitude, a frequency or a phase shift.

It is also possible to consider changes in frequency or seasonality, the addition of breaks or outliers.

For acquired data that would be tabular data, a transformation may, e.g., aim to add outliers and/or spurious correlations between the original acquired data.

The generation unit 20 is controlled by a control unit adapted to inhibit the operation thereof.

The control unit inhibits the generation unit when the data acquired at the input of the estimation unit 14 does not belong to the predefined operational domain. In fact, by construction, the estimation unit 14 is not suitable for estimating a quantity from data outside the predefined operational domain and the evaluation of robustness or stability in such context makes no sense. The computation unit 22 is a unit suitable for estimating a value of the physical quantity by applying the same estimation model to the test data as the estimation unit 14. The value estimated by the computation unit 22 is thereby a test value.

The computation unit 22 is thus a digital twin of the estimation unit 14.

In operation, the only difference is that the computation unit 22 operates on input data different from the data of the estimation unit 14. Such input data are different in the sense that the input data of the computation unit 22 are test data generated from data actually acquired to reproduce data that could be acquired in the future.

The computation unit 22 is thereby used to determine the behavior of the estimation model in the presence of the test data, i.e., modified input data to simulate noisy input data or abnormal input data.

The analysis unit 24 is a unit for analyzing the test value.

According to the example described, the analysis unit 24 comprises two evaluation subunits.

The first evaluation subunit 28 is a subunit for evaluating the robustness of the estimation model.

As mentioned hereinabove, the estimation model is considered robust when the estimation model may continue to function properly despite abnormal inputs and conditions outside the predefined operational domain.

The evaluation of the robustness consists of determining whether the estimation model is robust or not according to a criterion.

Such criterion is, e.g., the percentage of incorrect operation in the presence of a predefined number of tests of the estimation model with abnormal inputs.

The first evaluation subunit 28 compares the test value (at the output of the computation unit 22) with an expected value (at the output of the estimation unit 14) which is an indication of the presence of abnormal data at the input of the estimation model.

The second evaluation subunit 30 is a subunit for evaluating the stability of the estimation model.

According to the previous definition, it is recalled herein that the estimation model is considered stable if same can continue to function correctly despite perturbations of the inputs thereof within the predefined operational domain.

An example of a criterion of stability is the concept of “bounded inputs, bounded outputs” or “invariance of the output class”.

The second evaluation subunit 30 performs a comparison between the test value (at the output of the computation unit 22) and an expected value which is the output value of the estimation unit 14.

The alert unit 26 is adapted to issue an alert depending upon of the result of the comparison.

In the example described, the alert unit is adapted to issue an alert when, for a number of times greater than a predefined threshold, the result of the comparison corresponds to a criterion that has not been fulfilled.

The control unit 18 is adapted to emit an output value for the estimation system 10 depending both on the estimated value and on the output of the warning unit 26.

For example, in the simplest implementation, the control unit 18 will output the estimated acquired value determined by the estimation unit 14 when the warning unit does not issue an alert and in the opposite case will transmit the alert message issued by the warning unit instead of the output of the estimation unit 14.

A specific example is now described to illustrate the operation of the different subunits of the analysis unit 24.

An estimation model is considered, that would be adapted to classify the input data according to three output classes, a first class C1, a second class C2 and an anomaly class CA.

The first evaluation subunit 28 then evaluates the robustness of the evaluation model according to the following decision table:

TABLE 1

| Output | Output | | Estimated |
|---|---|---|---|
| of the | of the | | status for the |
| estimation | computing | Comparison | robustness of the |
| unit 14 | unit 22 | result | estimation model |
| C1 | C1 | criterion not met | yes |
| C1 | C2 | criterion not met | yes |
| C1 | CA | criterion met | no |
| C2 | C1 | criterion not met | yes |
| C2 | C2 | criterion not met | yes |
| C2 | CA | criterion met | no |
| CA | C1 | not performed | not evaluated |
| CA | C2 | not performed | not evaluated |
| CA | CA | not performed | not evaluated |

In the preceding table, a “yes” status corresponds to an estimation unit 14 operating locally (i.e., for the particular test data) in a non-robust manner and vice versa, a “no” status corresponds to an estimation unit 14 operating locally in a robust manner.

The case of an already abnormal acquired data is considered irrelevant insofar as the generation unit 20 does not modify the data. Thereof does not make it possible to test robustness.

The second evaluation subunit 30 then evaluates the stability of the evaluation model according to the following decision table:

TABLE 2

| Output | Output | | Estimated |
|---|---|---|---|
| of the | of the | | status for the |
| estimation | computing | Comparison | stability of the |
| unit 14 | unit 22 | result | estimation model |
| C1 | C1 | criterion met | no |
| C1 | C2 | criterion not met | yes |
| C1 | CA | criterion not met | yes |
| C2 | C1 | criterion not met | yes |
| C2 | C2 | criterion met | no |
| C2 | CA | criterion not met | yes |
| CA | C1 | not performed | not evaluated |
| CA | C2 | not performed | not evaluated |
| CA | CA | not performed | not evaluated |

In the preceding table, a “yes” status corresponds to an estimation unit 14 operating locally (i.e., for said particular test data) in an unstable manner and vice versa, a “no” status corresponds to an estimation unit 14 operating locally in a stable manner.

Herein again, the case of an already abnormal acquired data is considered irrelevant insofar as the generation unit 20 does not modify the data. In other words, one is not interested in the stability of the 14 estimation model outside the predefined operational domain (ODD).

On the basis of such elements, it is the warning unit 26 which will determine whether an alert should actually be issued or not.

In the sense thereof, the warning unit 26 synthesizes the information coming from the two evaluation subunits 28 and 30.

For this purpose, the warning unit 26 may carry out the analysis over a measurement period (herein a measurement is the output of the evaluation subunits, i.e., whether or not an alert is issued for the stability or the robustness).

The warning unit 26 accumulates the measurements and when the number of measurements is greater than a threshold N, the warning unit 26 implements, e.g., a synthesis technique as described hereinafter.

For the measurements k to k-N (k being an integer greater than or equal to N), the number of alarms issued is compared with a threshold, exceeding the threshold causing an alarm to be issued for the property (stability or robustness) in question.

Alternatively, it is possible to consider the percentage of alarms issued instead of the number of alarms issued.

The monitoring device 16 which has just been described serves to verify the correct functioning of the estimation unit 14 during the phase of use of the estimation unit 14 in production or in operation in the real environment.

More specifically, the monitoring device 16 serves to determine whether the estimation model used by the estimation unit 14 retains satisfactory robustness and stability throughout the production or operational life cycle thereof.

The monitoring system 16 thus performs a predictive control of robustness and stability using a hybrid approach in the sense that same is based on both data and rules (sometimes referred to as “data and rule driven”).

The predictive control is based on the generation unit 20 serving as an online generator of adversarial examples that will be used to produce perturbed or abnormal inputs, on the computation unit 22 which is a digital twin of the estimation unit 14 and on decision tables which will produce a verdict on the robustness and the stability of the estimation model.

The predictive nature of the control makes possible a preventive intervention, which is not possible with the existing techniques which are reactive.

The fact that the control may be performed in real time and under real operating conditions is also innovative in that, as a result, it is possible to continue in production the verification of the robustness and of the stability of the estimation model in order to complete the verification effort already made in the factory during the development phase and which, in practice, is often incomplete.

Such approach is particularly suitable for estimation models carrying out a “classification” or “regression” operation, but can be extended to other types of estimation.

The search for robustness and stability is found in many areas of industry, so that the monitoring device 16 may advantageously be used in fields such as aeronautics, space, defense, energy, land transport, health or the chemical industry.

It should be indeed understood that the monitoring device 16 is also interesting even if same performs only one of the two analyzes (robustness or stability).

As such, in the most general case, the test value analysis unit 24 performs at least one comparison between the test value and an expected value according to at least one criterion in order to obtain a comparison result, each criterion being a criterion for evaluating the performance of the estimation model and the warning unit 26 issuing an alert depending on the result of the comparison.

In the example just described, the generation module 20, the computation module 22, the analysis module 24 and the warning module 26 are each implemented in the form of a software program, or a software brick, which may be executed by the processor.

The memory of the monitoring device 16 is then adapted to store generation software, a computation software and an analysis a software and a warning software. The processor is then adapted to execute each of the software programs among the generation software, a computation software and an analysis software and a warning software.

All of the units can be developed using software technologies such as C++, Java, C, “Rust” (registered trademark), “Go” (registered trademark) or “Python” (registered trademark). The choice of programming language will be defined by the level of criticality level of the estimation system 10. The platform where the units will be executed will depend on the use case. It may be a single conventional server or a station with local or edge computing graphics processing units (GPUs), or a distributed platform.

In a variant (not shown), the generation module 20, the computation module 22, the analysis unit 24 and the warning unit 26 are each produced in the form a programmable logic component, such as an FPGA (Field Programmable Gate Array), or else of an integrated circuit, such as an ASIC (Application Specific Integrated Circuit).

When the monitoring 16 is produced in the form of one or a plurality of software programs, i.e., in the form of a computer program, also called a computer program product, same is further adapted for being recorded on a computer-readable medium (not shown). The computer-readable medium is, e.g., a medium adapted to store the electronic instructions and to be coupled to a bus of a computer system. As an example, the readable medium is an optical disk, a magneto-optical disk, a ROM, a RAM, any type of non-volatile memory (e.g., FLASH or NVRAM) or a magnetic card. A computer program containing software instructions is then stored on the readable medium.

What has just been described in terms of physical implementation is also valid for the estimation unit 14 and the control unit 18.

The remarks concerning the physical implementation of the generation units 20, the computation unit 22, the analysis unit 24 and the warning unit 26 are also valid for the subunits that said units contain.

It should also be noted herein that units may contain more subunits than the subunits shown in FIG. 1.

More particularly, the generation unit 20 may include a subunit for each use case, i.e., a first subunit applying the transformations suitable for the evaluation of the stability (first use case) and a second subunit applying the transformations suitable for evaluating the robustness (second use case).

1. A predictive monitoring device for the operation of an estimator for a physical quantity, the estimator receiving data acquired by a detector and applying an estimation model on the acquired data to obtain an estimated value, the estimation model being adapted to give an estimated value of the physical quantity over a predefined operational domain, the predictive monitoring device comprising:
a generator for test data, the generator receiving the data acquired by the detector and applying a transformation on the acquired data to obtain test data, the test data being data observable by the detector and on which the application of the estimation model gives an expected value;
a processor estimating a value of the physical quantity by applying to the test data the same estimation model as the estimator to obtain a test value;
an analyzer for the test value, the analyzer performing at least one comparison between the test value and an expected value according to at least one criterion for obtaining a comparison result, each criterion being a criterion for evaluating the performance of the estimator; and
an alarm issuing an alert according to the result of the comparison.

2. The predictive monitoring device according to claim 1, wherein the generator applies a transformation adding noise into the acquired data.

3. The predictive monitoring device according to claim 1, the generator applies a function for generating abnormal data, an abnormal datum being a datum that does not belong to the predefined operational domain.

4. The predictive monitoring device according to claim 1, wherein a criterion used by said analyzer is a criterion of robustness of the estimation model and the expected value is an indication of the presence of an abnormal datum at the input of the estimation model.

5. The predictive monitoring device according to claim 1, wherein a criterion used by said analyzer is a stability criterion and the expected value is the estimated value.

6. The predictive monitoring device according to claim 1, wherein said alarm issues an alert when, for a number of times greater than a predefined threshold, the result of the comparison corresponds to a criterion that has not been fulfilled.

7. The estimation system of a physical quantity, the estimation system comprising:
an estimator receiving data acquired by a detector and applying an estimation model on the acquired data to obtain an estimated value, the estimation model being suitable for giving an estimated value of the physical quantity over a predefined operational domain; and
a predictive monitoring device of the estimator, the predictive monitoring device being according to claim 1.

8. The estimation system according to claim 7, further comprising a detector acquiring data.

9. The estimation system according to claim 7, further comprising a controller issuing an output value for the estimation system depending both on the estimated value and on an output of the alarm.

10. A method of predictive monitoring for the operation of an estimator for a physical quantity, the estimator receiving data acquired by a detector and applying an estimation model on the acquired data to obtain an estimated value, the estimation model being suitable for giving an estimated value of the physical quantity over a predefined operational domain, the method comprising:
generating test data, comprising:
receiving the data acquired by the detector; and
applying a transformation on the acquired data to obtain test data, the test data being data observable by the detector and on which the application of the estimation model gives an expected value;
estimating a value of the physical quantity by applying to the test data the same estimation model as the estimator, in order to obtain a test value;
analyzing the test value, comprising at least one comparing between the test value and an expected value according to at least one criterion for obtaining a comparison result, each criterion being a criterion for evaluating the performance of the estimation model; and
issuing an alert according to the result of the comparison.

11. A method of estimation of a physical quantity comprising:
receiving, by an estimator, data acquired by a detector;
applying an estimation model on the acquired data to obtain an estimated value, the estimation model being suitable for giving an estimated value of the physical quantity over a predefined operational domain; and
implementing a predictive monitoring method according to claim 10.
